(19) United States
(12) Patent Application Publication
(10) Pub. No.: US 2024/0399498 A1
(43) Pub. Date: Dec. 5, 2024

(54) WELDING METHOD AND WELDING STRUCTURE OF METAL MEMBER

(71) Applicant: Panasonic Intellectual Property Management Co., Ltd., Osaka (JP)

(72) Inventors: Seiji KUMAZAWA, Hyogo (JP); Yuta TSUJI, Hyogo (JP); Takayuki HIROSE, Osaka (JP)

(21) Appl. No.: 18/696,221

(22) PCT Filed: Jun. 30, 2022
(86) PCT No.: PCT/JP2022/026389

§ 371 Date: Mar. 27, 2024

(30) Foreign Application Priority Data
Sep. 28, 2021 (JP) 2021-157831

(51) Int. Cl. B23K 26/073; B23K 26/24; B23K 26/323; B23K 101/36; B23K 103/02; B23K 103/12; H01M 50/534; H01M 50/536

(52) U.S. Cl. CPC B23K 26/073; B23K 26/24; B23K 26/323; H01M 50/534; H01M 50/536; B23K 2101/36; B23K 2103/02; B23K 2103/12

(57) ABSTRACT

In a metal member, a second member is overlaid on a second surface of a first member, the first member having a first surface and the second surface that face in opposite directions. A solidified portion is a portion produced by melting the first member from the first surface thereof as far as the second member via the second surface. The solidified portion has a bead protruding from the first surface. Defining a first direction and a second direction that intersect within the first surface, the bead has a line shape more elongated along the first direction than along the second direction, and the bead does not have depression.

### TECHNICAL FIELD

The present disclosure relates to a welding method and a welding structure of a metal member.

### BACKGROUND ART

A line-shaped laser beam is used for laser annealing, and, in particular, to turn an a-Si thin film of a liquid crystal display into a p-Si member. The line-shaped laser beam is shaped by dividing an incident laser beam into a predetermined number of beams, rearranging the beams into an arrangement different from that of the incident beam, and providing a uniform intensity (see, for example, PATENT LITERATURE 1).

### RELATED-ART LITERATURE

### Patent Literature

Patent Literature 1: JP2008-177372

### SUMMARY OF INVENTION

### Technical Problem

Laser processing with a line-shaped laser beam has been conventionally performed. In general, however, a line-shaped laser beam is not used to weld the metal of a plate member. The first reason resides in a difference in the amount of heat input. When a line-shaped laser beam is used to remelt a-Si, a pulse laser on the us order can be used for heating and the irradiation time is as short as u to several tens of μs because, although the melting point of Si is as high as 1430° C., the depth heated is as small as several μm into the surface. On the other hand, welding a metal several hundred μm or more requires a heating time of several tens of ms or more, and welding cannot be performed with a pulsed laser on the us order or less. The second reason is that, if the shorter side of a welded metal member is too short, the joint width will be too small so that a joint strength cannot be obtained. Therefore, a bead width of several hundred μm or more is required. This results in a large amount of heat escaping at the ends of the line-shaped laser beam and in a welding quality that differs between the center and at the ends.

The present disclosure addresses the issue described above, and a purpose thereof is to provide a technology for improving welding quality in line-shaped welding.

### Solution to Problem

A welding method according to an embodiment of the present disclosure includes: overlaying a second member on a second surface of a first member, the first member having a first surface and the second surface that face in opposite directions; irradiating the first surface of the first member with a line-shaped laser beam; and causing a solidified portion formed by irradiation with the line-shaped laser beam to join the first member and the second member, wherein, defining a first direction and a second direction that intersect within the first surface, the line-shaped laser beam is longer along the first direction than along the second direction, and wherein a beam intensity at a first end and a second end, which are ends of the line-shaped laser beam in the first direction, is higher than a beam intensity in a central portion of the line-shaped laser beam sandwiched by the first end and the second end.

Another embodiment of the present disclosure relates to a welding method. The method includes: overlaying a second member on a second surface of a first member, the first member having a first surface and the second surface that face in opposite directions; irradiating the first surface of the first member with a line-shaped laser beam; and causing a solidified portion formed by irradiation with the line-shaped laser beam to join the first member and the second member, wherein, defining a first direction and a second direction that intersect within the first surface, the line-shaped laser beam is longer along the first direction than along the second direction, and wherein, defining ends of the line-shaped laser beam in the first direction as a first end and a second end and defining a central portion between the first end and the second end of the line-shaped laser beam, a beam width in the second direction at the first end and the second end is wider than a beam width in the second direction in the central portion.

Still another embodiment of the present disclosure relates to a welding structure of a metal member. The welding structure is a welding structure of a metal member in which a second member is overlaid on a second surface of a first member, the first member having a first surface and the second surface that face in opposite directions, the welding structure including a solidified portion produced by melting the first member from the first surface as far as the second member via the second surface. The solidified portion has a bead protruding from the first surface. Defining a first direction and a second direction that intersect within the first surface, the bead has a line shape more elongated along the first direction than along the second direction. The bead does not have a depression.

Optional combinations of the aforementioned constituting elements, and implementations of the disclosure in the form of methods, apparatuses, and systems may also be practiced as additional aspects of the present disclosure.

### Advantageous Effects of Invention

According to the present disclosure, welding quality in line-shaped welding is improved.

### BRIEF DESCRIPTION OF DRAWINGS

FIGS. 1A-1D show a welding structure according to a comparative example of the embodiment.

FIG. 2 is a cross-sectional view showing a structure of the metal member according to the embodiment.

FIGS. 3A-3C show a configuration of a welding apparatus according to the embodiment.

FIGS. 4A-4C show a structure for injecting an assist gas in the welding apparatus of FIG. 3A.

FIGS. 5A-5C show a welding structure according to the embodiment.

FIGS. 6A-6D are further figures showing a welding structure according to the embodiment.

FIGS. 7A-7B show a welding structure 20 according to a variation.

### DESCRIPTION OF EMBODIMENTS

Hereinafter, the present disclosure will be described based on preferred embodiments with reference to drawings. The embodiments do not limit the scope of the present disclosure but exemplify the disclosure. Not all of the features and the combinations thereof described in the embodiments are necessarily essential to the present disclosure. Identical or like constituting elements, members, processes shown in the drawings are represented by identical symbols and a duplicate description will be omitted as appropriate. The scales and shapes shown in the figures are defined for convenience's sake to make the explanation easy and shall not be interpreted limitatively unless otherwise specified. Terms like “first”, “second”, etc. used in the specification and claims do not indicate an order or importance by any means unless otherwise specified and are used to distinguish a certain feature from the others. Some of the members that are not material to the description of the embodiments are omitted in the drawings.

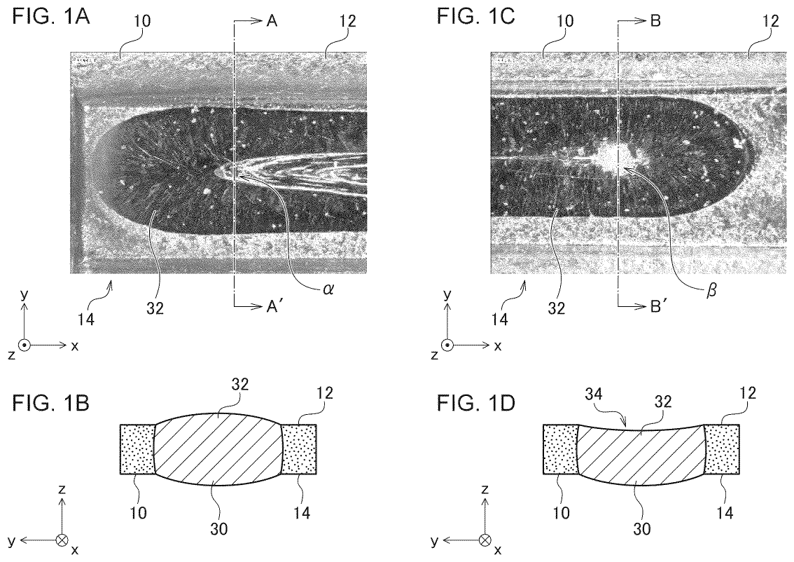

FIGS. 1A-1D show a welding structure according to a comparative example of the embodiment. In the comparative example, line-shaped laser welding is performed on a plate-shaped metal member 10 having a first surface 12 and a second surface 14 that face in opposite directions. As shown in FIGS. 1A-1D, an orthogonal coordinate system formed by an x axis, y axis, and z axis is defined. The x-axis and the y-axis are at right angles to each other within the first surface 12 of the metal member 10. Denoting the direction of the x-axis as “the first direction”, the direction of the y-axis is denoted as “the second direction”. Further, the z-axis is aligned with the direction of thickness of the metal member 10. Denoting the positive direction side along the z-axis as “the upper side”, the negative direction side along the z-axis is denoted as “the lower side”. In the comparison example, the first surface 12 is irradiated with laser. In general, when the plate-shaped metal member 10 is to be welded, line-shaped welding is performed by using a spot created by narrowing a laser beam for a scan by means of a scanner, etc. because high power density is required for welding between metal members.

FIG. 1A is a plan view of the vicinity of a start point α in the welding structure of the comparative example viewed from the side of the first surface 12, and FIG. 1B is a cross-sectional view along A-A′ line of FIG. 1A. The start point α is a point where scanning by spot laser irradiation is started. A solidified portion 30 is formed by laser irradiation on the first surface 12. The solidified portion 30 is a portion where the metal member 10 melted by laser irradiation has been solidified after completion of laser irradiation. The solidified portion 30 has a bead 32 protruding from the first surface 12. FIG. 1C is a plan view of the vicinity of an end point β in the welding structure of the comparative example viewed from the side of the first surface 12, and FIG. 1D is a cross-sectional view along B-B′ line of FIG. 1C. The end point β is a point where scanning by spot laser irradiation is completed. Referring to FIGS. 1C-1D, the solidified portion 30 is formed in the same manner as in FIGS. 1A-1B. However, there is a depression 34 in the bead 32.

When spot scanning is performed, it is difficult to control input of heat at the start point α and the end point β. At the start point α, it is possible to form a certain protrusion of the bead 32 by low-speed scanning, etc. At the end point β, on the other hand, a depression 34 will be formed despite any attempt. As a result, the bead 32 of a uniform shape is not formed in the longer side direction (e.g., over the extent in the x direction), and the welding quality is reduced.

Hereinafter, the welding method and welding structure for improving welding quality in line-shaped laser welding will be described in the order of (1) lamination step, (2) laser irradiation step, and (3) solidification step. Further, the orthogonal coordinate system including the x-axis, y-axis, and z-axis is defined as already described.

### (1) Lamination Step

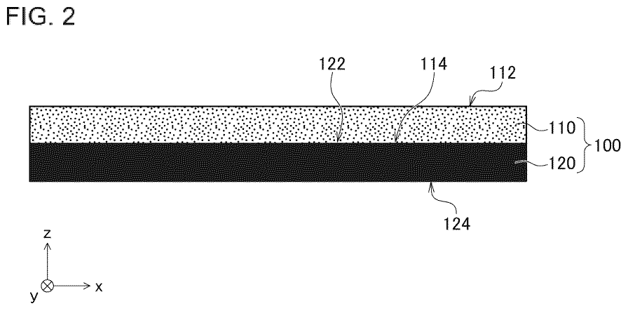

FIG. 2 is a cross-sectional view showing a structure of the metal member 100. The metal member 100 includes a first member 110 and a second member 120. The first member 110 and the second member 120 may be made of the same metal or may be made of different metals. The first member 110 has a first surface 112 and a second surface 114 that face in opposite directions. For example, the first surface 112 faces upward, and the second surface 114 faces downward. The second member 120 has a third surface 122 and a fourth surface 124 facing in opposite directions. For example, the third surface 122 faces upward, and the fourth surface 124 faces downward. The first member 110 and the second member 120 are overlaid so that the third surface 122 of the second member 120 is aligned with the second surface 114 of the first member 110.

### (2) Laser Irradiation Step

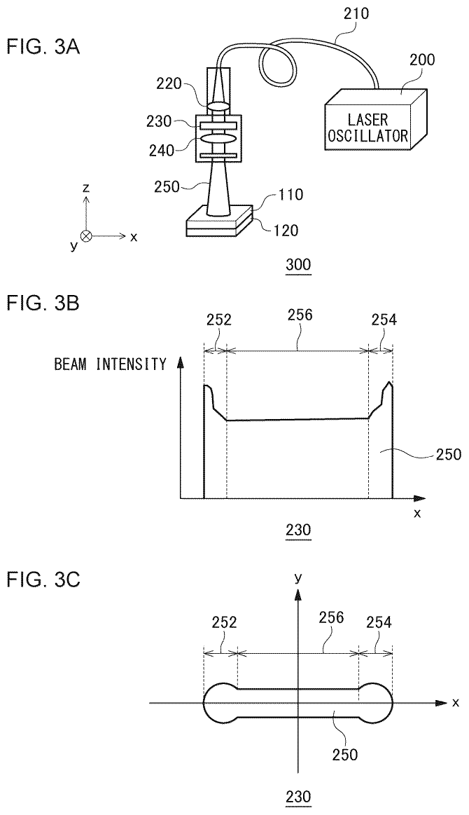

FIGS. 3A-3C show a configuration of a welding apparatus 300. The welding apparatus 300 shown in FIG. 3A includes a laser oscillator 200, an optical fiber 210, a collimator 220, a beam homogenizer 230, and a condenser lens 240. The laser oscillator 200 radiates a laser beam such as a solid-state laser. The laser beam is projected onto the collimator 220 via the optical fiber 210. The collimator 220 parallelizes the laser beam from the optical fiber 210.

The beam homogenizer 230 splits the laser beam incident from the collimator 220 into a plurality beams. The direction of travel of the incident laser beam is, for example, the negative direction along the z-axis. The beam homogenizer 230 rotates and arranges each of the split laser beams to a predetermined angle within the x-y plane orthogonal to the negative direction along the z-axis. As a result, the divided laser beams differ in the value in the x direction and the value in the y direction. That is, the split laser beam is rearranged into an arrangement different from that of the incident laser beam. Further, the beam homogenizer 230 forms a line-shaped laser beam 250 from the rearranged laser beams. For example, the line-shaped laser beam 250 is configured to be longer along the x-axis direction more than along the y-axis direction.

FIG. 3B shows the beam intensity of the line-shaped laser beam 250 shaped by the beam homogenizer 230. The horizontal axis represents the x-axis in which the line-shaped laser beam 250 extends, and the vertical axis represents the beam intensity. The ends of the line-shaped laser beam 250 in the x-axis direction are shown as a first end 252 and a second end 254. Further, a portion of the line-shaped laser beam 250 sandwiched between the first end 252 and the second end 254 is shown as a central portion 256. The beam homogenizer 230 configures the beam intensity at the first end 252 and the second end 254 to be higher than the beam intensity in the central portion 256. This is to configure the amount of heat applied at the first end 252 and the second end 254 to be larger than that of the central portion 256, in consideration of the fact that the heat escapes more easily during welding at the first end 252 and the second end 254 than in the central portion 256. If the heat that escapes during welding is large, it is difficult to form the bead.

FIG. 3C shows the shape of the line-shaped laser beam 250 shaped by the beam homogenizer 230. The figure shows the x-y plane as viewed from the positive direction side along the z-axis. In FIG. 3C, as in FIG. 3B, the first end 252, the second end 254, and the central portion 256 are shown. The beam homogenizer 230 configures the beam width in the y-axis direction at the first end 252 and the second end 254 to be wider than the beam width in the y-axis direction in the central portion 256. This is also to configure the amount of heat applied at the first end 252 and the second end 254 to be larger than that of the central portion 256, in consideration of the fact that the heat escapes more easily during welding at the first end 252 and the second end 254 than in the central portion 256. Reference is made back to FIG. 3A. The beam homogenizer 230 radiates the line-shaped laser beam 250 onto the first surface 112 of the first member 110 via the condenser lens 240.

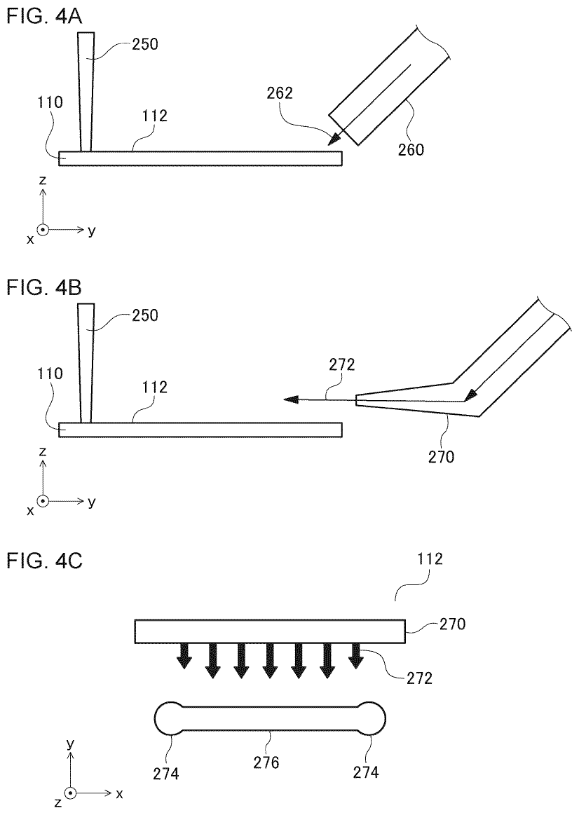

FIGS. 4A-4C show injection of an assist gas in the welding apparatus 300. In the welding apparatus 300, an assist gas is injected onto the portion on the first surface 112 irradiated with the laser beam 250 to prevent metal oxidation and promote welding during laser welding. The assist gas is, for example, a nitrogen gas. That is, an assist gas is injected onto the first surface 112 when the first surface 112 of the first member 110 is irradiated with the line-shaped laser beam 250.

FIG. 4A shows a structure for injecting an assist gas according to a comparative example. FIG. 4A show the y-axis aligned with the horizontal direction. A nozzle 260 is disposed to face the first surface 112, and the nozzle 260 injects an assist gas 262 onto the first surface 112. The assist gas 262 is reflected by the first surface 112 and reaches the portion irradiated with the laser beam 250, engulfing the air around the first surface 112. In the case of such a structure, the metal is oxidized as the air is engulfed by the assist gas 262.

FIG. 4B shows a structure for injecting an assist gas according to the embodiment. Like FIG. 4A, FIG. 4B show the y-axis in the horizontal direction. A nozzle 270 is disposed along the first surface 112, and the nozzle 270 injects an assist gas 272 along the first surface 112. The assist gas 272 reaches the portion irradiated with the laser beam 250 along the first surface 112. In this case, the amount of air engulfed is less than that of FIG. 4A so that oxidation of the metal is suppressed.

FIG. 4C shows a case where the first surface 112 is viewed from the positive direction side along the Z axis. The portion of the first surface 112 irradiated with the first end 252 and the second end 254 of the line-shaped laser beam 250 is shown as a first portion 274, and the portion irradiated with the central portion 256 of the line-shaped laser beam 250 is shown as a second portion 276. The nozzle 270 extends in the x-axis direction to conform to the line-shaped laser beam 250 and injects the assist gas 272. The flow rate of the assist gas 272 injected onto the first portion 274 is configured to be smaller than the flow rate of the assist gas 272 onto the second portion 276. This is to configure the amount of heat applied at the first end 252 and the second end 254 to be larger than that of the central portion 256, in consideration of the fact that the heat escapes more easily during welding at the first end 252 and the second end 254 than in the central portion 256 and that the assist gas 272 has a heat dissipation effect.

### (3) Solidification Step

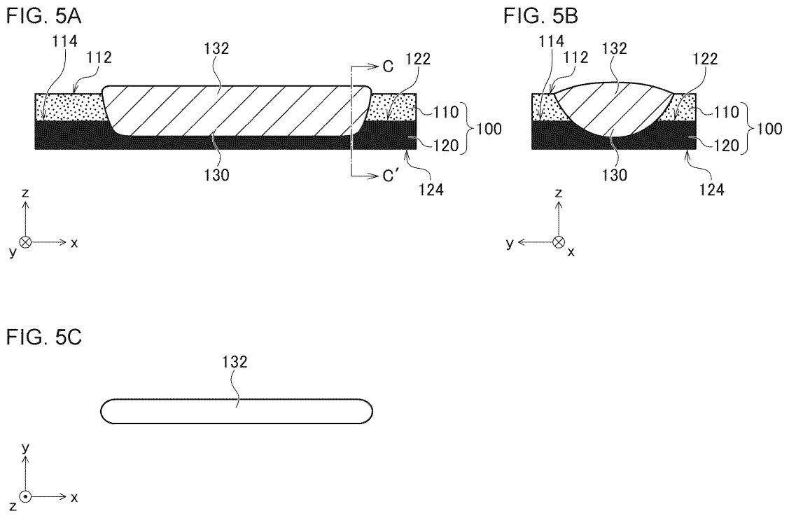

When irradiation with the line-shaped laser beam 250 is completed, the metal member 100 undergoes a solidification step. FIGS. 5A-5C show a welding structure. FIG. 5A is a structure as viewed in the same direction as FIG. 2, FIG. 5B is a cross-sectional view along C-C′ line of FIG. 5A, and FIG. 5C shows a structure viewed from the positive direction side along the z-axis. The first member 110 and the second member 120 in the metal member 100 are shown in the same manner as in FIG. 2, and the second member 120 is overlaid on the second surface 114 of the first member 110. A solidified portion 130 is formed by irradiating the first surface 112 with the line-shaped laser beam 250. The solidified portion 130 is a portion in which the first member 110 and the second member 120 melted by laser irradiation are solidified after completion of laser irradiation. It can be said that the solidified portion 130 is a portion produced by melting the first member 110 from the first surface 112 thereof as far as the second member 120 via the second surface 114. The solidified portion 130 joins the first member 110 and the second member 120.

The solidified portion 130 has a bead 132 that protrudes from the first surface 112 and is more elongated in the x-axis direction than in the y-axis direction. For example, the length of the bead 132 in the x-axis direction is configured to be 10 times or more than the length of the bead 132 in the y-axis direction. Further, the bead 132 does not have a depression. It can be said that the central portion of the bead 132 in the cross-sectional shape in the y-axis direction bulges over the entire extent in the x-axis direction. In particular, the ends of the line-shaped bead 132 bulge.

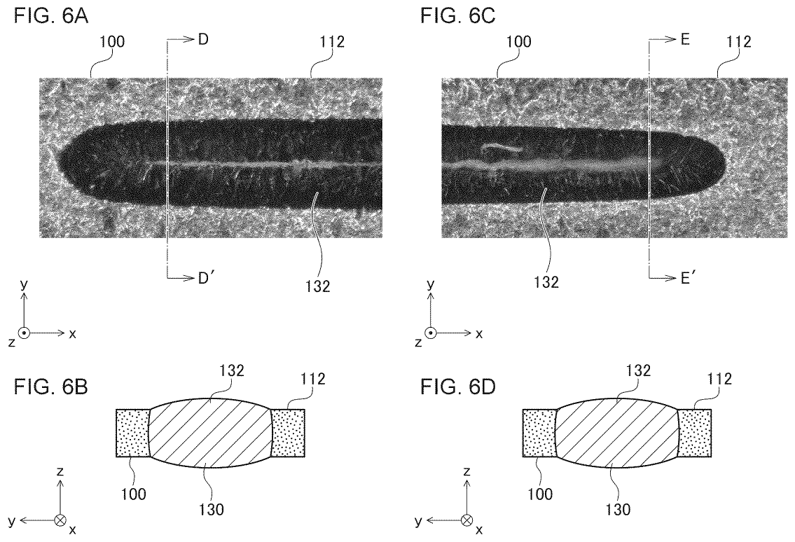

FIGS. 6A-6D show a welding structure and are shown for comparison with FIGS. 1A-1D. FIG. 6A is a plan view of the vicinity of the negative side end of the welding structure along the x-axis viewed from the side of the first surface 112, and FIG. 6B is a cross-sectional view along D-D′ line of FIG. 6A. The bead 132 in the solidified portion 130 protrudes from the first surface 112. FIG. 6C is a plan of the vicinity of the positive end of the x-axis in the welded structure as viewed from the side of the first surface 112, and FIG. 6D is a cross-sectional view along E-E′ line of FIG. 6C. The bead 132 in the solidified portion 130 protrudes from the first surface 112, and there is no depression in the bead 132.

The welding method and welding structure described so far may be used in a battery such as a lithium ion secondary battery. The battery has a structure in which an electrode group is stored in an outer can along with a electrolytic solution. The electrode group has a winding structure in which a belt-like electrode plate and a belt-like separator are stacked and are then wound in a spiral shape. A current collector plate is provided toward one end of the electrode group. The electrode plate and the current collector plate are joined by laser welding, etc.

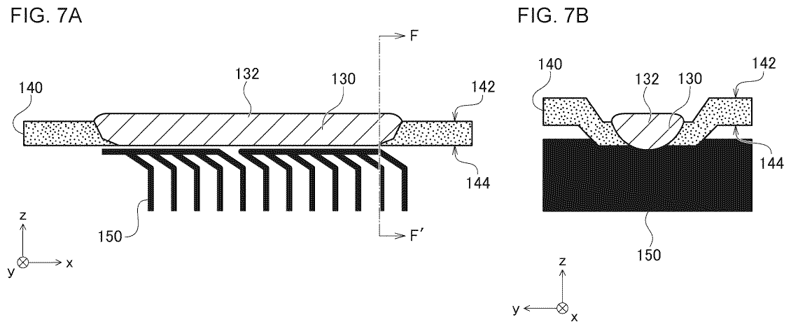

FIGS. 7A-7B show a welding structure according to a variation. This corresponds to a welding structure applied to end-face current collection at a negative electrode of a battery. A current collector plate 140 has a first surface 142 and a second surface 144 that face in opposite directions. The current collector plate 140 is made of, for example, nickel-plated iron. The current collector plate 140, the first surface 142, and the second surface 144 correspond to the first member 110, the first surface 112, and the second surface 114 described so far. The electrode plate 150 is formed by a copper foil. The electrode plate 150 corresponds to the second member 120. The current collector plate 140 and the electrode plate 150 are joined by the solidified portion 130. The welding structure may be applied to end-face current collection in a positive electrode of a battery. In that case, the current collector plate 140 is formed by, for example, an aluminum plate, and the electrode plate 150 is formed by an aluminum foil.

According to the embodiment, the beam intensity at the ends of the line-shaped laser beam 250 is configured to be higher than the beam intensity in the central portion 256. It is therefore possible to ensure similar equal welding quality in the central portion 256 and at the ends in the longer side direction even if the heat escapes more easily at the ends than in the central portion 256. Further, since it is possible to ensure similar welding quality in the central portion 256 and at the ends in the longer side direction, the welding quality in line-shaped welding is improved. Further, since the beam width at the ends is configured to be wider than the beam width in the central portion 256, it is possible to ensure similar welding quality in the central portion 256 and at the ends in the longer side direction even if the heat escapes more easier at the ends than in the central portion 256.

Since the flow rate of the assist gas 272 at the ends is configured to be smaller than the flow rate of the assist gas 272 in the central portion, a temperature drop during welding due to the assist gas 272 can be suppressed. Further, since a temperature drop during welding due to the assist gas 272 is suppressed, the welding quality in line-shaped welding is improved. Further, since the assist gas 272 is injected along the first surface 112, the amount of air engulfed by the assist gas 272 is suppressed. Further, since the amount of air engulfed by the assist gas 272 is suppressed, oxidation of the metal member 100 is suppressed.

Further, since there are no depressions at the ends of the line-shaped bead 132, it is possible to ensure similar welding quality in the central portion and at the ends in the longer side direction. Further, since it is possible to ensure similar welding quality in the central portion and at the ends in the longer side direction, stable welding is realized. Further, since stable welding is realized, high-quality welding is stably provided at low cost. Further, since there are no movable parts of a laser apparatus such as a scanner, high-speed welding is realized with high reliability and high availability. Further, since high-speed welding is realized with high reliability and high availability, high-quality and low-cost batteries are provided. Further, since the length of the bead 132 in the longer side direction is 10 times or more than the length in the shorter side direction, the line-shaped bead 132 is realized.

The embodiments of the present disclosure are described above in detail. The embodiments described above are merely specific examples of practicing the present disclosure. The details of the embodiments shall not be construed as limiting the technical scope of the present disclosure. A number of design modifications such as modification, addition, deletion, etc. of constituting elements may be made to the extent that they do not depart from the idea of the present disclosure defined by the claims. New embodiments with design modifications will provide the combined advantages of the embodiment and the variation. Although the details subject to such design modification are emphasized in the embodiment described above by using phrases such as “of this embodiment” and “in this embodiment”, details not referred to as such may also be subject to design modification. Any combination of the above constituting elements is also useful as a mode of the present disclosure. Hatching in the cross section in the drawings should not be construed as limiting the material of the hatched object.

The disclosure according to the embodiment described above may be defined by the following items.

### [Item 1]

A welding method including:
overlaying a second member (120) on a second surface (114) of a first member (110), the first member (110) having a first surface (112) and the second surface (114) that face in opposite directions;
irradiating the first surface (112) of the first member (110) with a line-shaped laser beam (250); and
causing a solidified portion (130) formed by irradiation with the line-shaped laser beam (250) to join the first member (110) and the second member (120),
wherein, defining a first direction and a second direction that intersect within the first surface (112), the line-shaped laser beam (250) is longer along the first direction than along the second direction, and
wherein a beam intensity at a first end (252) and a second end (254), which are ends of the line-shaped laser beam (250) in the first direction, is higher than a beam intensity in a central portion (256) of the line-shaped laser beam (250) sandwiched by the first end (252) and the second end (254).

### [Item 2]

The welding method according to ITEM 1,
wherein a beam width in the second direction at the first end (252) and the second end (254) is wider than a beam width in the second direction in the central portion (256).

### [Item 3]

A welding method including:
overlaying a second member (120) on a second surface (114) of a first member (110), the first member (110) having a first surface (112) and the second surface (114) that face in opposite directions;
irradiating the first surface (112) of the first member (110) with a line-shaped laser beam (250); and
causing a solidified portion (130) formed by irradiation with the line-shaped laser beam (250) to join the first member (110) and the second member (120),
wherein, defining a first direction and a second direction that intersect within the first surface (112), the line-shaped laser beam (250) is longer along the first direction than along the second direction, and
wherein, defining ends of the line-shaped laser beam (250) in the first direction as a first end (252) and a second end (254) and defining a central portion (256) between the first end (252) and the second end (254) of the line-shaped laser beam (250), a beam width in the second direction at the first end and (252) the second end (254) is wider than a beam width in the second direction in the central portion (256).

### [Item 4]

The welding method according to any one of ITEMS 1 through 3, further including:
injecting an assist gas (272) onto the first surface (112) when irradiating the first surface (112) of the first member (110) with the line-shaped laser beam (250),
wherein a flow rate of the assist gas (272) injected onto a first portion (274) of the first surface (112) irradiated with the first end (252) and the second end (254) of the line-shaped laser beam (250) is smaller than a flow rate of the assist gas (272) injected onto a second portion (276) irradiated with the central portion (256) of the line-shaped laser beam (250).

### [Item 5]

The welding method according to ITEM 4,
wherein the assist gas (272) is injected along the first surface (112).

### [Item 6]

The welding method according to any one of ITEMS 1 through 3, further including:
injecting an assist gas (272) onto the first surface (112) when irradiating the first surface (112) of the first member (110) with the line-shaped laser beam (250),
wherein the assist gas (272) is injected along the first surface (112).

### [Item 7]

A welding structure of a metal member (100) in which a second member (120) is overlaid on a second surface (114) of a first member (110), the first member (110) having a first surface (112) and the second surface (114) that face in opposite directions,
the welding structure including:
a solidified portion (130) produced by melting the first member (110) from the first surface (112) as far as the second member (120) via the second surface (114),
wherein the solidified portion (130) has a bead (132) protruding from the first surface (112),
wherein, defining a first direction and a second direction that intersect within the first surface (112), the bead (132) has a line shape more elongated along the first direction than along the second direction, and
wherein the bead (132) does not have a depression.

### [Item 8]

The welding structure of a metal member (100) according to ITEM 7,
wherein a length of the bead (132) in the first direction is 10 times or more than a length of the bead (132) in the second direction.

### [Item 9]

The welding structure of a metal member (100) according to ITEM 7 or 8,
wherein the first member (110) is a current collector plate (140) of a battery, and
wherein the second member (120) is an electrode plate (150) of the battery.

### [Item 10]

The welding structure of a metal member according to ITEM 9,
wherein the current collector plate (140) is made of nickel-plated iron, and
wherein the electrode plate (150) is formed by a copper foil.

### INDUSTRIAL APPLICABILITY

According to the present disclosure, welding quality in line-shaped welding is improved.

### REFERENCE SIGNS LIST

10 metal member, 12 first surface, 14 second surface, 30 solidified portion, 32 bead, 34 depression, 100 metal member, 110 first member, 112 first surface, 114 second surface, 120 second member, 122 third surface, 124 fourth surface, 130 solidified portion, 132 bead, 140 current collector plate, 142 first surface, 144 second surface, 150 electrode plate, 200 laser oscillator, 210 optical fiber, 220 collimator, 230 beam homogenizer, 240 condenser lens, 250 laser beam, 252 first end, 254 second end, 256 central portion, 260 nozzle, 262 assist gas, 270 nozzle, 272 assist gas, 274 first portion, 276 second portion, 300 welding apparatus, a start point, β end point

1. A welding method comprising:
overlaying a second member on a second surface of a first member, the first member having a first surface and the second surface that face in opposite directions;
irradiating the first surface of the first member with a line-shaped laser beam; and
causing a solidified portion formed by irradiation with the line-shaped laser beam to join the first member and the second member,
wherein, defining a first direction and a second direction that intersect within the first surface, the line-shaped laser beam is longer along the first direction than along the second direction, and
wherein a beam intensity at a first end and a second end, which are ends of the line-shaped laser beam in the first direction, is higher than a beam intensity in a central portion of the line-shaped laser beam sandwiched by the first end and the second end.

2. The welding method according to claim 1,
wherein a beam width in the second direction at the first end and the second end is wider than a beam width in the second direction in the central portion.

3. A welding method comprising:
overlaying a second member on a second surface of a first member, the first member having a first surface and the second surface that face in opposite directions;
irradiating the first surface of the first member with a line-shaped laser beam; and
causing a solidified portion formed by irradiation with the line-shaped laser beam to join the first member and the second member,
wherein, defining a first direction and a second direction that intersect within the first surface, the line-shaped laser beam is longer along the first direction than along the second direction, and
wherein, defining ends of the line-shaped laser beam in the first direction as a first end and a second end and defining a central portion between the first end and the second end of the line-shaped laser beam, a beam width in the second direction at the first end and the second end is wider than a beam width in the second direction in the central portion.

4. The welding method according to claim 1, further comprising:
injecting an assist gas onto the first surface when irradiating the first surface of the first member with the line-shaped laser beam,
wherein a flow rate of the assist gas injected onto a first portion of the first surface irradiated with the first end and the second end of the line-shaped laser beam is smaller than a flow rate of the assist gas injected onto a second portion irradiated with the central portion of the line-shaped laser beam.

5. The welding method according to claim 4,
wherein the assist gas is injected along the first surface.

6. The welding method according to claim 1, further comprising:
injecting an assist gas onto the first surface when irradiating the first surface of the first member with the line-shaped laser beam,
wherein the assist gas is injected along the first surface.

7. A welding structure of a metal member in which a second member is overlaid on a second surface of a first member, the first member having a first surface and the second surface that face in opposite directions,
the welding structure comprising:
a solidified portion produced by melting the first member from the first surface as far as the second member via the second surface,
wherein the solidified portion has a bead protruding from the first surface,
wherein, defining a first direction and a second direction that intersect within the first surface, the bead has a line shape more elongated along the first direction than along the second direction, and
wherein the bead does not have a depression.

8. The welding structure of a metal member according to claim 7,
wherein a length of the bead in the first direction is 10 times or more than a length of the bead in the second direction.

9. The welding structure of a metal member according to claim 7,
wherein the first member is a current collector plate of a battery, and
wherein the second member is an electrode plate of the battery.

10. The welding structure of a metal member according to claim 9,
wherein the current collector plate is made of nickel-plated iron, and
wherein the electrode plate is formed by a copper foil.
